(19) United States
(12) Patent Application Publication
(10) Pub. No.: US 2026/0162633 A1
(43) Pub. Date: Jun. 11, 2026

(54) PORTABLE HAND DRUM DEVICE

(71) Applicant: Jerry Meyer, Morrison, CA (US)

(72) Inventor: Jerry Meyer, Morrison, CA (US)

(21) Appl. No.: 18/973,928

(22) Filed: Dec. 9, 2024

(51) Int. Cl. G10D 13/02; G10D 13/06; G10D 13/12; G10D 13/16; G10D 13/18; G10D 13/20; G10D 13/22; G10G 5/00

(52) U.S. Cl. CPC G10D 13/02; G10D 13/06; G10D 13/12; G10D 13/16; G10D 13/18; G10D 13/20; G10D 13/22; G10G 5/005

(57) ABSTRACT

A portable hand drum device includes a first drum shell and a shoulder strap attached to the first drum shell and a first drum head that is removably attachable to the first drum shell. A striking rod is pivotally attached to the first drum shell and a beater rod is pivotally coupled to the first drum shell. The beater rod strikes the first drum head when the striking rod is depressed to produce an audible sound. A second drum shell is coupled to the first drum shell and a second drum head is removably attachable to the second drum shell which produces an audible sound when the second drum head is struck. A lever is pivotally attached to the first drum shell and a shaker is coupled to the lever and the shaker produces an audible sound when the lever is pivoted.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to hand drum devices and more particularly pertains to a new hand drum device for producing a variety of percussive sounds. The device includes a first drum shell and a shoulder strap attached to the first drum shell and a first drum head attached to the first drum shell. The device includes a striker rod pivotally attached to the first drum head and a beater rod pivotally attached to the first drum head which is in mechanical communication with the striker rod and which beats the first drum head when a user depresses the striker rod. The device includes a second drum shell attached to the first drum shell and a second drum head attached to the second drum shell when can be struck by the user. Additionally, the device includes a lever that is pivotally attached to the first drum shell and a shaker attached to the lever.

### (2) Description of Related Art Including Information Disclosed Under 37 CFR 1.97 and 1.98

The prior art relates to hand drum devices including: a multiple tone drum that includes a first drum shell and a second drum shell perpendicular to the first drum shell and a third drum shell perpendicular to the first drum shell; a drum device that includes a conga and a drum mount that is attachable to the conga and a drum that is mounted to the drum mount such that the drum is positioned beneath the conga; a hybrid drum apparatus which includes a box and a conga that extends through the box and a drum that is attached to the box; a percussion instrument that includes a box and a plurality of drum heads each attached to the box; a percussive instrument device that includes a first conga and a second conga that is attached to and extends laterally away from the first conga; an ornamental design for a conga display that includes a first pair of congas and a bridge coupled between the first pair of congas and a second pair of congas and a bridge coupled between the second pair of congas. In no instance does the prior art disclose a portable hand drum device that includes a first drum shell and a second drum shell perpendicular to the first drum shell and a striking rod pivotally attached to the first drum shell and a beater rod pivotally attached to the first drum shell which strikes a first drum head when the striker rod is manipulated and a lever pivotally attached to the first drum shell and a shaker attached to the lever.

### (h) BRIEF SUMMARY OF THE INVENTION

An embodiment of the disclosure meets the needs presented above by generally comprising a first drum shell and a shoulder strap attached to the first drum shell and a first drum head that is removably attachable to the first drum shell. A striking rod is pivotally attached to the first drum shell and a beater rod is pivotally coupled to the first drum shell. The beater rod strikes the first drum head when the striking rod is depressed to produce an audible sound. A second drum shell is coupled to the first drum shell and a second drum head is removably attachable to the second drum shell which produces an audible sound when the second drum head is struck. A lever is pivotally attached to the first drum shell and a shaker is coupled to the lever and the shaker produces an audible sound when the lever is pivoted.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a portable hand drum device according to an embodiment of the disclosure.

FIG. 2 is a left side view of an embodiment of the disclosure.

FIG. 3 is a front view of an embodiment of the disclosure.

FIG. 4 is a cross sectional view taken along line 4-4 of FIG. 2 of an embodiment of the disclosure.

FIG. 5 is a cross sectional view taken along line 5-5 of FIG. 3 of an embodiment of the disclosure.

FIG. 6 is a back perspective view of an embodiment of the disclosure.

FIG. 7 is a perspective in-use view of an embodiment of the disclosure.

### (J) DETAILED DESCRIPTION OF THE INVENTION

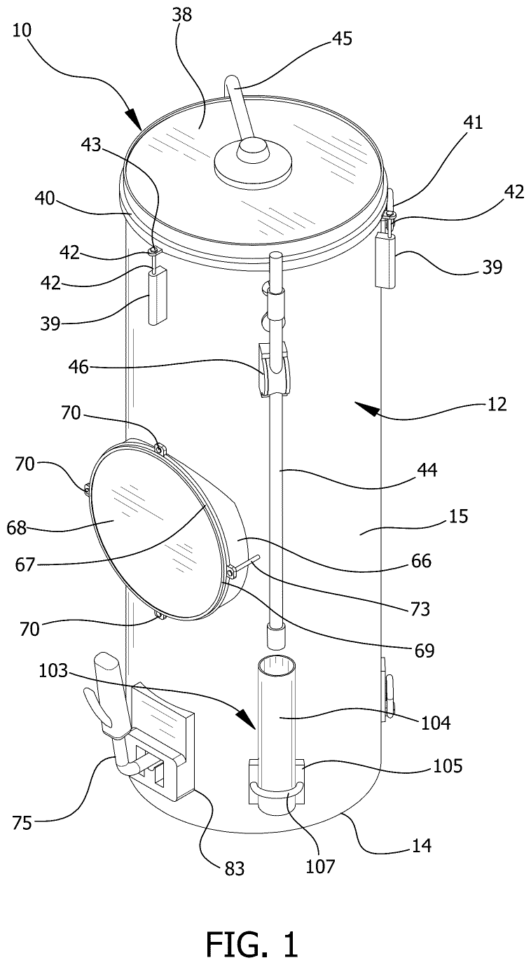

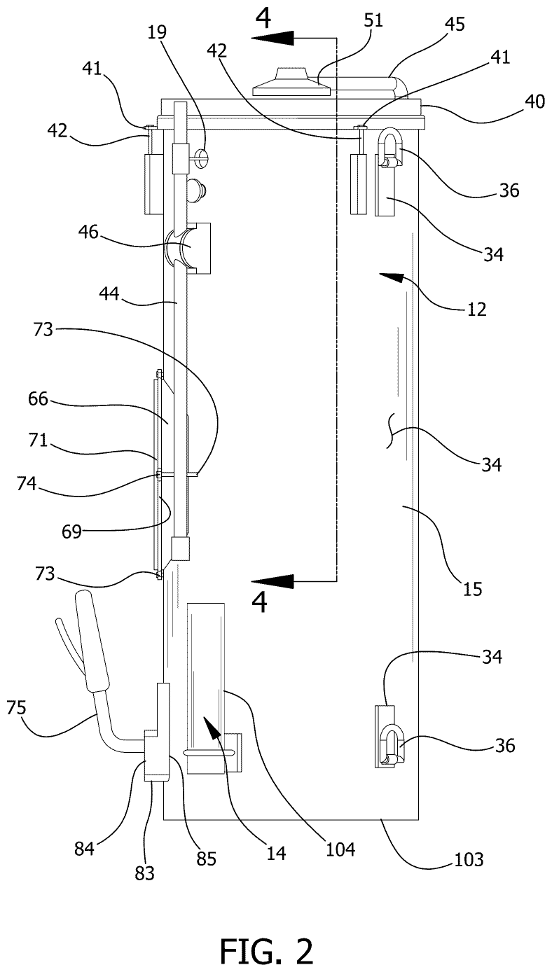

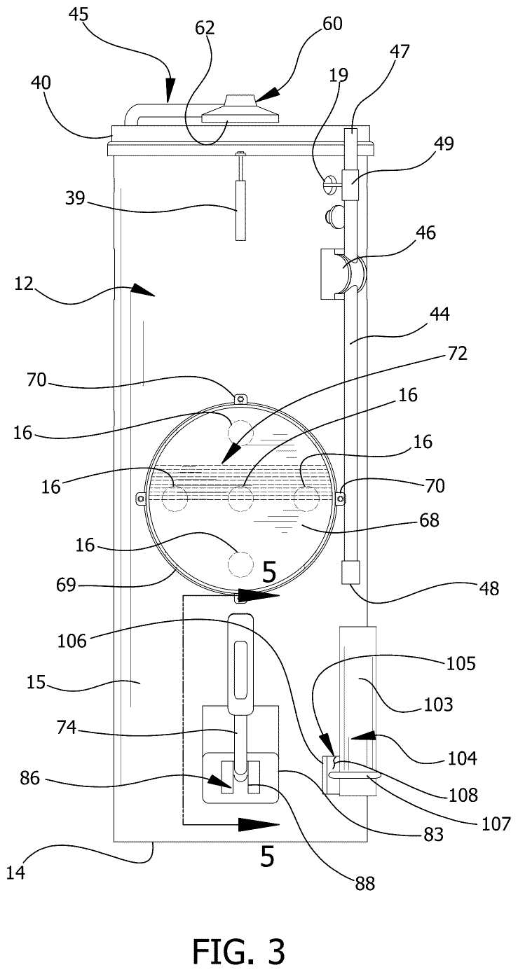

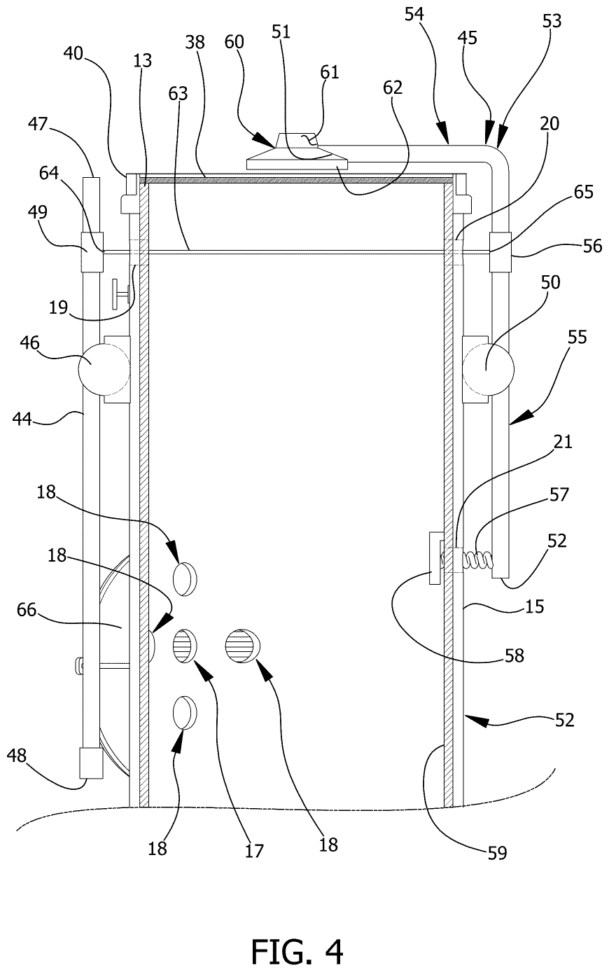

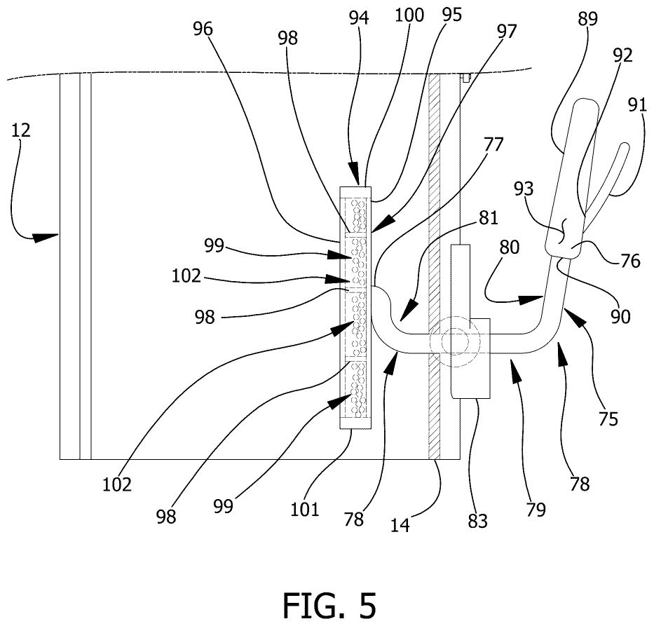

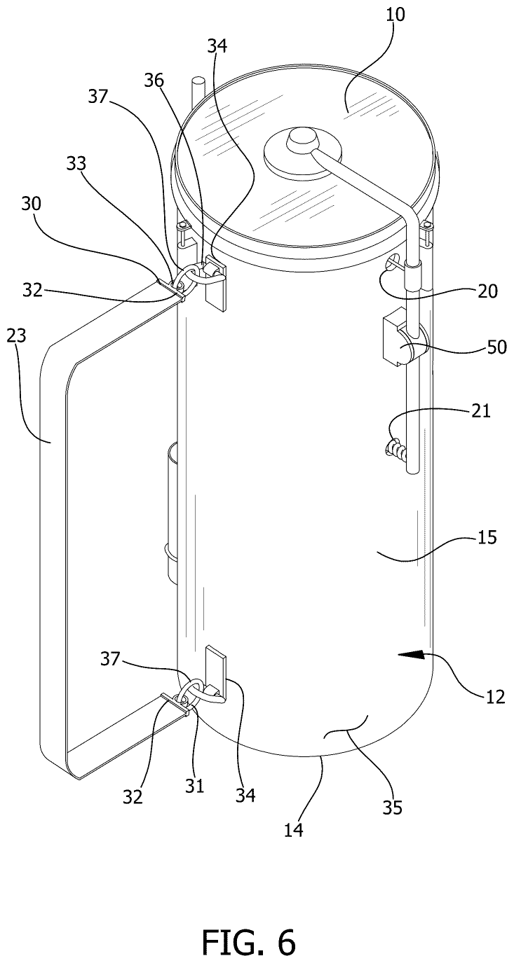

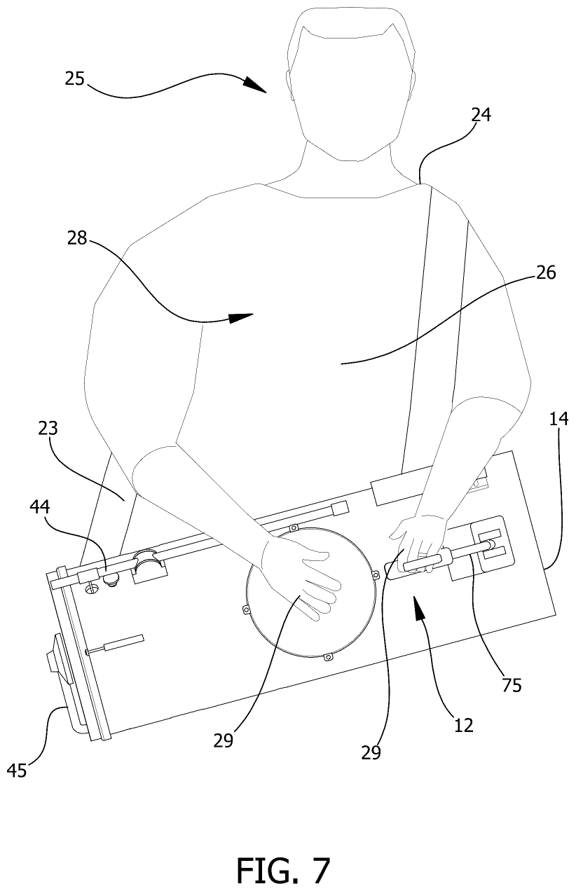

With reference now to the drawings, and in particular to FIGS. 1 through 7 thereof, a new hand drum device embodying the principles and concepts of an embodiment of the disclosure and generally designated by the reference numeral 10 will be described.

As best illustrated in FIGS. 1 through 7, the portable hand drum device 10 generally comprises a first drum shell 12 which is comprised of an acoustically resonant material, including but not being limited to wood, such as maple or birch, such that the first drum shell 12 can amplify sound waves that travel through the first drum shell 12. The first drum shell 12 has a first end 13 and a second end 14 and an outer wall 15 extending between the first end 13 and the second end 14. Each of the first end 13 and the second end 14 is open to pass air through the first drum shell 12 such that sound waves can pass through the first drum shell 12. The first drum shell 12 may have a length ranging between approximately 75.0 cm and 100.0 cm and a diameter ranging between approximately 25.0 cm and 30.0 cm.

The first drum shell 12 has a plurality of sound holes 16 each extending through the outer wall 15 of the first drum shell 12 to pass air through the outer wall 15. The plurality of sound holes 16 includes a central hole 17 and a plurality of outer holes 18 distributed around the central hole 16. Furthermore, the plurality of sound holes 16 is centrally located between the first end 13 and the second end 14 of the first drum shell 12. The first drum shell 12 has a first cable hole 19 extending through the outer wall 15 and the first cable hole 19 is located closer to the first end 13 than the second end 14. The first drum shell 12 has a second cable hole 20 extending through the outer wall 15 and the second cable hole 20 is positioned on an opposite side of the outer wall 15 with respect to the first cable hole 19 having the second cable hole 20 being aligned with the first cable hole 19. The first drum shell 12 has a spring hole 21 extending through the outer wall 15 and the spring hole 21 is positioned between the second cable hole 20 and the second end 14 of the first drum shell 12. Furthermore, the spring hole 21 is aligned with the second cable hole 20.

A shoulder strap 23 is provided and the shoulder strap 23 is attached to the first drum shell 12. The shoulder strap 23 can be worn over a shoulder 24 of a user 25 thereby positioning the first drum shell 12 on a front side 26 of the user's upper body 28 such that hands 29 of the user 25 can touch the first drum shell 12. The shoulder strap 23 has a primary end 30 and a secondary end 31; a pair of retainers 32 is each attached to a respective one of the primary end 30 and the secondary end 31 of the shoulder strap 23. Additionally, each retainer 32 of the pair of retainers 32 has an annular hoop 33 that is formed into a respective retainer 32.

A pair of strap mounts 34 is each attached to an outer surface 35 of the outer wall 15 of the first drum shell 12. Each strap mount 34 of the pair of strap mounts 34 is spaced from a respective one of the first end 13 and the second end 14 of the first drum shell 12 having the pair of strap mounts 34 being aligned with each other. Each strap mount 34 of the pair of strap mounts 34 includes a hoop 36 which is movably attached to a respective strap mount 34. A pair of annular rings 37 each extends through the annular hoop 33 of a respective retainer 32 and the hoop 36 of a respective strap mount 34 such that the shoulder strap 23 is movably attached to each strap mount 34 of the pair of strap mounts 34.

A first drum head 38 is provided and the first drum shell 12 is removably attachable to the first drum shell 12. The first drum head 38 is comprised of a resonant material, including but not being limited to plastic or animal skin or aramid fiber, such the first drum head 38 can produce an audible sound when the first drum head 38 is struck. The audible sound produced by the first drum head 38 may be similar, in pitch and timber, to the audible sound of a bass drum. A plurality of drum lugs 39 is each attached to the outer surface 35 of the outer wall 15 of the first drum shell 12. The plurality of drum lugs 39 is spaced from the first end 13 of the first drum shell 12 and the plurality of drum lugs 39 is evenly spaced apart from each other and is distributed around a full circumference of the outer wall 15 of the first drum shell 12.

A first drum hoop 40 is positionable on the first end 13 of the first drum shell 12 such that the first drum hoop 40 extends around a full circumference of the first end 13. The first drum hoop 40 has a plurality of first tabs 41 each extending laterally away from the first drum hoop 40. Additionally, the plurality of first tabs 41 is evenly spaced apart from each other and is distributed around a full circumference of the first drum hoop 40. The first drum hoop 40 is oriented on the first end 13 such that each first tab 41 of the plurality of first tabs 41 is aligned with a respective one of the plurality of drum lugs 39. Furthermore, the first drum head 38 is positioned between the first drum hoop 40 and the first end 13 of the first drum shell 12 such that the first drum hoop 40 retains the first drum head 38 on the first end 13.

A plurality of first tension screws 42 is provided and each first tension screw 42 of the plurality of first tension screws 42 extends through a respective one of the plurality of first tabs 41 on the first drum head 38 and into a respective one of the plurality of drum lugs 39. The plurality of first tension screws 42 tightens the first drum hoop 40 onto the first end 13 of the first drum shell 12 thereby tensioning the first drum head 38 when each first tension screw 42 of the plurality of first tension screws 42 is tightened in the respective drum lug 39. Furthermore, each first tension screw 42 of the plurality of first tension screws 42 has a head 43 which compresses against the respective first tab 41 on the first drum hoop 40 to inhibit each first tension screw 42 of the plurality of first tension screws 42 from passing through the respective first tab 41 when the plurality of first tension screws 42 is tightened in the respective drum lug 39.

A striking rod 44 is provided and the striking rod 44 is pivotally attached to the first drum shell 12. The striking rod 44 can be depressed by a respective one of the user's hands 29 when the user 25 is wearing the shoulder strap 23. A beater rod 45 is pivotally coupled to the first drum shell 12 and the beater rod 45 is in mechanical communication with striking rod 44. Additionally, the beater rod 45 is in mechanical communication with the first drum head 38 such that the beater rod 45 strikes the first drum head 38 when the striking rod 44 is depressed. Furthermore, the first drum head 38 produces the audible sound when the user 25 depresses the striking rod 44.

A striker pivot 46 is attached to the outer surface 35 of the outer wall 15 of the first drum shell 12. The striker pivot 46 is positioned between the first cable hole 19 and the second end 14 of the first drum shell 12 having the striker pivot 46 being positioned closer to the first cable hole 19 than the second end 14. The striking rod 44 is pivotally attached to the striker pivot 46 such that the striking rod 44 is oriented parallel to the outer surface 35 of the outer wall 15 of the first drum shell 12 when the striking rod 44 is in a ready position. Furthermore, the striking rod 44 can be depressed by the user 25 when the user 25 is wearing the shoulder strap 23.

The striking rod 44 is positioned in the striker pivot 46 such that a first end 47 of the striking rod 44 is aligned with the first end 13 of the first drum shell 12. A portion of the striking rod 44 that extends between the striker pivot 46 and a second end 48 of the striking rod 44 can be pressed upon by the user 25. Furthermore, the striking rod 44 is pivotable into an actuating position having the second end 48 of the striking rod 44 being urged toward the outer wall 15 of the first drum shell 12 and having the first end 47 of the striking rod 44 being urged away from the outer wall 15 of the first drum shell 12. A striking sleeve 49 is provided and the striking sleeve 49 extends around the striking rod 44. The striking sleeve 49 is positioned between the striker pivot 46 and the first end 47 of the striking rod 44.

A beater pivot 50 is attached to the outer surface 35 of the outer wall 15 of the first drum shell 12. The beater pivot 50 is positioned between the second cable hole 20 and the second end 14 of the first drum shell 12 having the beater pivot 50 being positioned closer to the second cable hole 20 than the second end 14 of the first drum shell 12. The beater rod 45 has a primary end 51 and a secondary end 52 and a bend 53 located between the primary end 51 of the beater rod 45 and the secondary end 52 of the beater rod 45. The bend 53 defines a primary portion 54 of the beater rod 45 which is oriented perpendicular to a secondary portion 55 of the beater rod 45. The primary end 51 of the beater rod 45 is associated with the primary portion 54 and the secondary end 52 of the beater rod 45 is associated with the secondary portion 55; the bend 53 is positioned closer to the primary end 51 of the beater rod 45 than the secondary end 52 of the beater rod 45. The secondary portion 55 is pivotally attached to the beater pivot 50 such that the secondary portion 55 is oriented parallel to the outer surface 35 of the outer wall 15 and the primary portion 54 extends partially across the first end 13 of the first drum shell 12.

A beater sleeve 56 extends around the secondary portion 55 of the beater rod 45 and the beater sleeve 56 is positioned between the beater pivot 50 and the bend 53 in the beater rod 45. A biasing member 57 is coupled to the secondary portion 55 of the beater rod 45 such that the biasing member 57 extends through the spring hole 21 in the outer wall 15 of the first drum shell 12. A spring block 58 is coupled to an inside surface 59 of the outer wall 15 of the first drum shell 12 and the spring block 58 is aligned with the spring hole 21 in the outer wall 15 of the first drum shell 12. The biasing member 57 is coupled to the spring block 58 such that the biasing member 57 biases the beater rod 45 into a home position having the secondary portion 55 being oriented parallel to the outer surface 35 of the outer wall 15 and having the primary portion 54 being oriented parallel to the first drum head 38.

A beater 60 is included that has an outer surface 61 which is coupled to the primary end 51 of the beater rod 45. The beater 60 has a bottom surface 62 which is spaced from and is oriented parallel to the first drum head 38 when the beater rod 45 is in the home position. Furthermore, the bottom surface 62 of the beater 60 strikes the first drum head 38 when the beater rod 45 is urged into a beating position having the beater rod 45 being pivoted in the beater pivot 50. The pivoting of the beater rod 45 enables the first drum head 38 to produce the audible sound when the bottom surface 62 of the beater 60 strikes the first drum head 38.

A cable 63 is provided which extends through each of the first cable hole 19 and the second cable hole 20. The cable 63 has a first end 64 which is coupled to the striking sleeve 49 and the cable 63 has a second end 65 which is coupled to the beater sleeve 56. The beater rod 45 is urged into the beating position when the striking rod 44 is urged into the actuating position such that the bottom surface 62 of the beater 60 strikes the first drum head 38. Furthermore, the striking rod 44 is urged into the ready position when the biasing member 57 biases the beater rod 45 into the home position.

A second drum shell 66 is provided and the second drum shell 66 is coupled to the first drum shell 12. The second drum shell 66 is perpendicularly oriented with the first drum shell 12 such that the second drum shell 66 is accessible to a respective one of the user's hands 29 when the user 25 is wearing the shoulder strap 23. The second drum shell 66 extends laterally away the outer surface 35 of the outer wall 15 of the first drum shell 12 and the second drum shell 66 surrounds the plurality of sound holes 16 in the outer wall 15 of the first drum shell 12. Furthermore, the second drum shell 66 is comprised of an acoustically resonant material, including but not being limited to wood, such as maple or birch, such that the second drum shell 66 can amplify sound waves that travel through the second drum shell 66. The second drum shell 66 has a distal end 67 with respect to the outer wall 15 and the distal end 67 is open to air through the distal end 67 and the plurality of sound holes 16. Furthermore, the second drum shell 66 is oriented such that the distal end 67 lies on a plane which is oriented parallel an axis extending through the first end 13 of the first drum shell 12 and the second end 14 of the first drum shell 12.

A second drum head 68 is removably attachable to the second drum shell 66 such that the second drum head 68 can be struck by a respective one of the user's hands 29 when the user 25 is wearing the shoulder strap 23. The second drum head 68 is comprised of a resonant material, including but not being limited to plastic or animal skin or aramid fiber, such that the second drum head 68 can produce an audible sound when the second drum head 68 is struck by the user's respective hand 29. The audible sound produced by the second drum head 68 may be similar, in pitch and timber, to the audible sound produced by a snare drum. Furthermore, the audible sound produced by the second drum head 68 travels through the plurality of sound holes 16 in the outer wall 15 of the first drum shell 12 such that the first drum shell 12 can amplify the intensity of the audible sound produced by the second drum shell 66. Additionally, The second drum shell 66 is located proximate the second end 48 of the striking rod 44 such that the second drum shell 66 is positioned such that the user 25 can strike the second drum head 68 or depress the striking rod 44 with the same hand 29.

A second drum hoop 69 is positionable on the distal end 67 of the second drum shell 66 such that the second drum hoop 69 extends around a full circumference of the distal end 67. The second drum hoop 69 has a plurality of second tabs 70 each extending laterally away from the second drum hoop 69. The plurality of second tabs 70 is evenly spaced apart from each other and is distributed around a full circumference of the second drum hoop 69. Additionally, the second drum head 68 is positioned between the second drum hoop 69 and the distal end 67 of the second drum shell 66 such that the second drum hoop 69 retains the second drum head 68 on the distal end 67 of the second drum shell 66. Furthermore, the second drum hoop 69 is structured such that a top edge 71 of the second drum hoop 69 lies flush with the second drum head 68 to inhibit the user's hand 29 from striking against the top edge 71 of the second drum hoop 69 when the user 25 strikes the second drum head 68.

A plurality of snare wires 72 is provided and each snare wire 72 of the plurality of snare wires 72 is attached to the second drum hoop 69 such that each snare wire 72 of the plurality of snare wires 72 extends across the second drum hoop 69. The second drum head 68 rests against the plurality of snare wires 72 such that the plurality of snare wires 72 produce a snapping sound when the second drum head 68 is struck by the user's respective hand 29. The plurality of snare wires 72 may be snare drum wires of any conventional design, including but not being limited to steel snare wires or string snare wires, to enhance the similarity of the audible sound produced by the second drum head 68 with respect to the audible sound produced by a snare drum.

A plurality of second tension screws 73 is provided and each second tension screw 73 of the plurality of second tension screws 73 extends through a respective one of the plurality of second tabs 70 and extends into the outer wall 15 of the first drum shell 12. The plurality of second tension screws 73 tightens the second drum hoop 69 on the distal end 67 of the second drum shell 66 when each second tension screw 73 of the plurality of second tension screws 73 is threaded into the outer wall 15 of the first drum shell 12 thereby tensioning the second drum head 68. Each second tension screw 73 of the plurality of second tension screws 73 has a head 74 which compresses against the respective second tab 70 when the second tension screws 73 are threaded into the outer wall 15. Furthermore, the head 74 on each of the plurality of second tension screws 73 inhibits each second tension screw 73 of the plurality of second tension screws 73 from passing through the respective second tab 70 when each second tension screw 73 of the plurality of second tension screws 73 is threaded into the outer wall 15 of the first drum shell 12.

A lever 75 is pivotally attached to the first drum shell 12 and the lever 75 is pivoted with a respective one of the user's hands 29 when the user 25 is wearing the shoulder strap 23. The lever 75 has a first end 76 and a second end 77 and a pair of bends 78 located between the first end 76 and the second end 77 of the lever 75. The bends 78 in the lever 75 define a middle portion 79 of the lever 75 extending between and being perpendicularly oriented with each of a first portion 80 and a second portion 81 of the lever 75. The first portion 80 is associated with the first end 76 of the lever 75 and the second portion 81 is associated with the second end 77 of the lever 75.

The first drum shell 12 has a lever hole 82 extending through the outer wall 15 and the lever hole 82 is positioned closer to the second end 14 of the first drum shell 12 than the first end 13 of the first drum shell 12. Furthermore, the lever hole 82 is positioned between the plurality of sound holes 16 and the second end 14 of the first drum shell 12. The middle portion 79 of the lever 75 extends through the lever hole 82 in the outer wall 15 of the first drum shell 12 such that the first portion 80 is positioned outside of the first drum shell 12 and the second portion 81 is positioned inside of the first drum shell 12.

A pivot block 83 is provided which has a front surface 84 and a back surface 85; the pivot block 83 has a hole 86 extending through the front surface 84 and the back surface 85. The back surface 85 is coupled to the outer surface 35 of the outer wall 15 of the first drum shell 12 having the hole 86 in the pivot block 83 being aligned with the lever hole 82 in the outer wall 15 of the first drum shell 12. Furthermore, the pivot block 83 is located between the second end 14 of the first drum shell 12 and the second drum shell 66 having the primary portion 54 of the lever 75 extending toward the second drum shell 66. The primary portion 54 of the lever 75 is located such that the user 25 can pivot the lever 75 and strike the second drum head 68 while their hands 29 are oriented in a natural position. The middle portion 79 of the lever 75 extends through the hole 86 in the pivot block 83. The pivot block 83 has a pivot point 88 which is located in the hole 86 in the pivot block 83 and the middle portion 79 of the lever 75 is pivotally coupled to the pivot point 88.

A grip 89 is provided which has a coupled end 90 that is coupled to the first end 76 of the lever 75 such that the grip 89 is oriented colinear with the first portion 80 of the lever 75. The grip 89 can be gripped by a respective one of the user's hands 29 when the user 25 is wearing the shoulder strap 23 such that the user 25 can pivot the lever 75 toward the first drum shell 12. A handle 91 has a coupled end 92 which is coupled to an outside surface 93 of the grip 89. The handle 91 is oriented to angle away from the grip 89 such that the handle 91 can restrain the user's respective hand 29 between the grip 89 and the handle 91 such that the user 25 can pivot the lever 75 away from the first drum shell 12.

A shaker 94 is coupled to the lever 75 such that the shaker 94 is positioned within the first drum shell 12 and the shaker 94 has a rear wall 95 that is spaced from a front wall 96. A rear surface 97 of the rear wall 95 is attached to the second portion 81 of the lever 75 at a point is aligned with the second end 77 of the lever 75. The shaker 94 has a plurality of dividers 98 and each divider 98 of the plurality of dividers 98 extends between the front wall 96 and the rear wall 95 of the shaker 94 to define a plurality of chambers 99 within the shaker 94. The plurality of dividers 98 is spaced apart from each other and is distributed between a top wall 100 of the shaker 94 and a bottom wall 101 of the shaker 94.

A plurality of beads 102 is provided and each bead 102 of the plurality of beads 102 is positioned within the shaker 94. The plurality of beads 102 strike against the shaker 94 when the lever 75 is pivoted such that the shaker 94 produces an audible sound when the lever 75 is pivoted. Each bead 102 of the plurality of beads 102 is located within a respective one of the plurality of chambers 99 within the shaker 94. Furthermore, each chamber 99 of the plurality of chambers 99 limits a distance that each bead 102 of the plurality of beads 102 can travel within the shaker 94 when the lever 75 is pivoted such that each chamber 99 of the plurality of chambers 99 minimizes a duration of time between the lever 75 is pivoted and the plurality of beads 102 striking against the shaker 94. The limited distance of travel of the plurality of beads 102 enables the shaker 94 to produce the audible sound as soon as possible when the lever 75 is pivoted. Each bead 102 of the plurality of beads 102 is comprised of a rigid material, including but not being limited to steel or ceramic, to enhance an intensity of the audible sound produced by the plurality of beads 102 striking against the shaker 94. Additionally, the audible sound produced by the plurality of beads 102 striking against the shaker 94 may be similar to the audible sound produced by a closed high-hat cymbal.

A cylinder 103 is provided which has an exterior wall 104 that is disposed on the outer surface 35 of the outer wall 15 of the first drum shell 12. The cylinder 103 is elongated along the axis that extends between the first end 13 and the second end 14 of the first drum shell 12. Additionally, the cylinder 103 is positioned closer to the second end 14 of the first drum shell 12 than the second end 14 of the first drum shell 12 and the cylinder 103 is aligned with the striking rod 44. The cylinder 103 is comprised of a rigid and resonant material, including but not being limited to metal or plastic, such that the cylinder 103 produces an audible sound similar, in pitch and timbre, to the sound of a cow bell percussive instrument when the user 25 strikes the cylinder 103.

A block 105 is provided which has a back surface 106 that is coupled to outer surface 35 of the outer wall 15 of the first drum shell 12 at a point located between the second end 14 of the firs drum shell 12 and the striking rod 44. A fastener 107 is provided which is curved to form a U-shape and the fastener 107 is attached to a front surface 108 of the block 105 such that the fastener 107 forms an arch with respect to the front surface 108. Furthermore, the fastener 107 curves around the exterior wall 104 of the cylinder 103 to secure the cylinder 103 to the front surface 108 of the block 105. Furthermore, the cylinder 103 can be slid in the fastener 105 toward or away from the striking rod 44 to orient the cylinder 103 on the outer wall 15 of the first drum shell 12 according to the preferences of the user 25.

In use, the shoulder strap 23 is worn over one of the user's shoulders 24 such that the first drum shell 12 is suspended on the front side 26 of the user's upper body 28. The user 25 places one of their hands 29 between the handle 91 and the grip 89 on the lever 75 to pivot the lever 75 back and forth thereby producing the audible sound of the closed high hat with the shaker 94. Additionally, the user 25 employs their other hand 29 to either strike the second drum head 68 to produce the audible sound of the snare drum and or depress the striking rod 44 to enable the beater 60 to strike the first drum head 38 to produce the audible sound of the bass drum. The lever 75 and the second drum head 68 and the striking rod 44 enables the user 25 to produce the audible sounds of multiple percussion instruments, typically associated with a drum set, for a musical performance or for their own enjoyment. Additionally, the user 25 can strike the cylinder 103 to produce the audible sound of the cowbell.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable hand drum device being playable with hands of a user to produce a variety of percussive sounds, said device comprising:
a first drum shell being comprised of an acoustically resonant material wherein said first drum shell is configured to amplify sound waves that travel through said first drum shell;
a shoulder strap being attached to said first drum shell wherein said shoulder strap is configured to be worn over a shoulder of a user thereby positioning said first drum shell on a front side of the user's upper body such that hands of the user can touch said first drum shell;
a first drum head being removably attachable to said first drum shell, said first drum head being comprised of a resonant material wherein said first drum head is configured to produce an audible sound when said first drum head is struck;
a striking rod being pivotally attached to said first drum shell wherein said striking rod is configured to be depressed by a respective one of the user's hands when the user is wearing said shoulder strap;
a beater rod being pivotally coupled to said first drum shell, said beater rod being in mechanical communication with striking rod, said beater rod being in mechanical communication with said first drum head such that said beater rod strikes said first drum head when said striking rod is depressed wherein said first drum head is configured to produce the audible sound when the user depresses said striking rod;
a second drum shell being coupled to said first drum shell, said second drum shell being perpendicularly oriented with said first drum shell wherein said second drum shell is configured to be accessible to a respective hand of the user when the user is wearing said shoulder strap, said second drum shell being comprised of an acoustically resonant material wherein said second drum shell is configured to amplify sound waves that travel through said second drum shell;
a second drum head being removably attachable to said second drum shell wherein said second drum head is configured to be struck by a respective one of the user's hands when the user is wearing said shoulder strap, said second drum head being comprised of a resonant material wherein said second drum head is configured to produce an audible sound when said second drum head is struck by the user's respective hand;
a lever being pivotally attached to said first drum shell wherein said lever is configured to be pivoted with a respective one of the user's hands when the user is wearing said shoulder strap;
a shaker being coupled to said lever such that said shaker is positioned within said first drum shell; and
a plurality of beads, each bead of said plurality of beads being positioned within said shaker, said plurality of beads striking against said shaker when said lever is pivoted wherein said shaker is configured to produce an audible sound when said lever is pivoted.

2. The device according to claim 1, wherein:
said first drum shell has a first end and a second end and an outer wall extending between said first end and said second end;
each of said first end and said second end being open wherein each of said first end and said second end are configured to pass air through said first drum shell such that sound waves can pass through said first drum shell; and
said first drum shell has a plurality of sound holes each extending through said outer wall of said first drum shell wherein each sound hole of said plurality of sound holes is configured to pass air through said outer wall;
said plurality of sound holes is centrally located between said first end and said second end of said first drum shell;
said first drum shell has a first cable hole extending through said outer wall;
said first cable hole is located closer to said first end than said second end;
said first drum shell has a second cable hole extending through said outer wall of said first drum shell;
said second cable hole is positioned on an opposite side of said outer wall with respect to said first cable hole having said second cable hole being aligned with said first cable hole;
said first drum shell has a lever hole extending through said outer wall;
said lever hole is positioned closer to said second end of said first drum shell than said first end of said first drum shell; and
said lever hole is positioned between said plurality of sound holes and said second end of said first drum shell.

3. The device according to claim 1, wherein:
said first drum shell has an outer wall extending between a first end of said first drum shell and a second end of said first drum shell;
said shoulder strap having a primary end and a secondary end;
said device includes a pair of retainers;
each retainer of said pair of retainers is attached to a respective one of said primary end and said secondary end of said shoulder strap;
each retainer of said pair of retainers has an annular hoop being formed into a respective retainer;
said device includes a pair of strap mounts;
each strap mount of said pair of strap mounts is attached to an outer surface of said outer wall of said first drum shell;
each strap mount of said pair of strap mounts is spaced from a respective one of said first end and said second end of said first drum shell having said pair of strap mounts being aligned with each other;
each strap mount of said pair of strap mounts includes a hoop being movably attached to a respective strap mount;
said device includes a pair of annular rings; and
each annular ring of said pair of annular rings extends through said annular hoop of a respective retainer and said hoop of a respective strap mount such that said shoulder strap is movably attached to each strap mount of said pair of strap mounts.

4. The device according to claim 1, wherein:
said first drum shell has a first end and a second end and an outer wall extending between said first end and said second end;
said device includes a plurality of drum lugs;
each drum lug of said plurality of drum lugs is attached to an outer surface of said outer wall of said first drum shell;
said plurality of drum lugs is spaced from said first end of said first drum shell;
said plurality of drum lugs is evenly spaced apart from each other and is distributed around a full circumference of said outer wall of said first drum shell.

5. The device according to claim 4, wherein:
a first drum hoop is positionable on said first end of said first drum shell such that said first drum hoop extends around a full circumference of said first end;
said first drum hoop has a plurality of first tabs each extending laterally away from said first drum hoop;
said plurality of first tabs is evenly spaced apart from each other and is distributed around a full circumference of said first drum hoop;
said first drum hoop is oriented on said first end such that each first tab of said plurality of first tabs is aligned with a respective one of said plurality of drum lugs;
said first drum head is positioned between said first drum hoop and said first end of said first drum shell such that said first drum hoop retains said first drum head on said first end;
said device includes a plurality of first tension screws;
each first tension screw of said plurality of first tension screws extends through a respective one of said plurality of first tabs on said first drum head and into a respective one of said plurality of drum lugs for tightening said first drum hoop onto said first end of said first drum shell thereby tensioning said first drum head when each first tension screw of said plurality of first tension screws is tightened in said respective drum lug; and
each first tension screw of said plurality of first tension screws has a head which compresses against said respective first tab on said first drum hoop to inhibit each first tension screw of said plurality of first tension screws from passing through said respective first tab when said plurality of first tension screws is tightened in said respective drum lug.

6. The device according to claim 2, wherein:
said device includes a striker pivot being attached to said outer surface of said outer wall of said first drum shell; and
said striker pivot is positioned between said first cable hole and said second end of said first drum shell having said striker pivot being positioned closer to said first cable hole than said second end;
said striking rod is pivotally attached to said striker pivot such that said striking rod is oriented parallel to said outer surface of said outer wall of said first drum shell wherein said striking rod is configured to be depressed by the user;
said striking rod is positioned in said striker pivot such that a first end of said striking rod is aligned with said first end of said first drum shell wherein a portion of said striking rod that extends between said striker pivot and a second end of said striking rod is configured to be pressed upon by the user; and
said striking rod is pivotable into an actuating position having said second end of said striking rod being urged toward said outer wall of said first drum shell and having said first end of said striking rod being urged away from said outer wall of said first drum shell.

7. The device according to claim 2, wherein:
said device includes a beater pivot being attached to said outer surface of said outer wall of said first drum shell; and
said beater pivot is positioned between said second cable hole and said second end of said first drum shell having said beater pivot being positioned closer to said second cable hole than said second end of said first drum shell;
said beater rod has a primary end and a secondary end and a bend located between said primary end and said secondary end;
said bend defines a primary portion of said beater rod being oriented perpendicular to a secondary portion of said beater rod;
said primary end is associated with said primary portion;
said secondary end is associated with said secondary portion;
said bend is positioned closer to said primary end than said secondary end; and
said secondary portion is pivotally attached to said beater pivot such that said secondary portion is oriented parallel to said outer surface of said outer wall and said primary portion extends partially across said first end of said first drum shell.

8. The device according to claim 9, wherein:
said first drum shell has a spring hole extending through said outer wall of said first drum shell;
said spring hole is positioned between said second cable hole and said second end of said first drum shell having said spring hole being aligned with said second cable hole;
said device includes a biasing member being coupled to said secondary portion of said beater rod such that said biasing member extends through said spring hole in said outer wall of said first drum shell;
said device includes a spring block being coupled to an inside surface of said outer wall of said first drum shell;
said spring block is aligned with said spring hole in said outer wall of said first drum shell; and
said biasing member is coupled to said spring block such that said biasing member biases said beater rod into a home position having said secondary portion being oriented parallel to said outer surface of said outer wall and having said primary portion being oriented parallel to said first drum head.

9. The device according to claim 7, wherein:
said device includes a beater having an outer surface being coupled to said primary end of said beater rod;
said beater has a bottom surface being spaced from and being oriented parallel to said first drum head when said beater rod is in a home position; and
said bottom surface of said beater strikes said first drum head when said beater rod is urged into a beating position having said beater rod being pivoted in said beater pivot wherein said first drum head is configured to produce the audible sound when said bottom surface of said beater strikes said first drum head.

10. The device according to claim 9, wherein:
said device includes a beater sleeve extending around said beater rod;
said device includes a striking sleeve extending around said striking rod;
said device includes a cable extending through each of said first cable hole and said second cable hole;
said cable has a first end being coupled to said striking sleeve;
said cable has a second end being coupled to said beater sleeve; and
said beater rod is urged into said beating position when said striking rod is urged into an actuating position such that said bottom surface of said beater strikes said first drum head.

11. The device according to claim 2, wherein:
said second drum shell extends laterally away said outer surface of said outer wall of said first drum shell;
said second drum shell surrounds said plurality of sound holes in said outer wall of said first drum shell;
said second drum shell has a distal end with respect to said outer wall;
said distal end is open wherein said second drum shell is configured to pass air through said distal end and said plurality of sound holes; and
said second drum shell is oriented such that said distal end lies on a plane being oriented parallel an axis extending through said first end of said first drum shell and said second end of said first drum shell.

12. The device according to claim 11, wherein:
said device includes a second drum hoop being positionable on said distal end of said second drum shell such that said second drum hoop extends around a full circumference of said distal end;
said second drum head is positioned between said second drum hoop and said distal end of said second drum shell such that said second drum hoop retains said second drum head on said distal end of said second drum shell;
said second drum hoop has a plurality of second tabs each extending laterally away from said second drum hoop; and
said plurality of second tabs is evenly spaced apart from each other and is distributed around a full circumference of said second drum hoop.

13. The device according to claim 12, wherein:
said device includes a plurality of snare wires;
each snare wire of said plurality of snare wires is attached to said second drum hoop such that each snare wire of said plurality of snare wires extends across said second drum hoop; and
said second drum head rests against said plurality of snare wires wherein said plurality of snare wires is configured to produce a snapping sound when said second drum head is struck by the user's respective hand.

14. The device according to claim 12, wherein:
said device includes a plurality of first tension screws;
said device includes a plurality of second tension screws;
each second tension screw of said plurality of tension screws extends through a respective one of said plurality of second tabs and extends into said outer wall of said first drum shell for tightening said second drum hoop on said distal end of said second drum shell when each second tension screw of said plurality of second tension screws is threaded into said outer wall of said first drum shell thereby tensioning said second drum head; and
each second tension screw of said plurality of second tension screws has a head which compresses against said respective second tab when said second tension screws are threaded into said outer wall to inhibit each second tension screw of said plurality of second tension screws from passing through said respective second tab when each second tension screw of said plurality of second tension screws is threaded into said outer wall of said first drum shell.

15. The device according to claim 2, wherein:
said lever has a first end and a second end and a pair of bends being located between said first end and said second end of said lever to define a middle portion of said lever extending between and being perpendicularly oriented with each of a first portion and a second portion of said lever;
said first portion is associated with said first end of said lever;
said second portion is associated with said second end of said lever;
said middle portion of said lever extends through said lever hole in said outer wall of said first drum shell such that said first portion is positioned outside of said first drum shell and said second portion is positioned inside of said first drum shell;
said device includes a pivot block having a front surface and a back surface;
said pivot block has a hole extending through said front surface and said back surface;
said back surface is coupled to said outer surface of said outer wall of said first drum shell having said hole in said pivot block being aligned with said lever hole in said outer wall of said first drum shell such that said pivot block is located between said second end of said first drum shell and said second drum shell having said primary portion of said lever extending toward said second drum shell wherein said primary portion of said lever is configured to be located such that the user can pivot said lever and strike said second drum head while their hands are in a natural position;
said middle portion of said lever extends through said hole in said pivot block and said lever hole in said outer wall of said first drum shell;
said pivot block has a pivot point being located in said hole in said pivot block; and
said middle portion of said lever is pivotally coupled to said pivot point.

16. The device according to claim 15, wherein:
said device includes a grip having a coupled end being coupled to said first end of said lever such that said grip is oriented colinear with said first portion of said lever wherein said grip is configured to be gripped by a respective one of the user's hands when the user is wearing said shoulder strap such that the user can pivot said lever toward said first drum shell;
said device includes a handle having a coupled end being coupled to an outside surface of said grip;
said handle is oriented to angle away from said grip wherein said handle is configured to restrain the user's respective hand between said grip and said handle such that the user can pivot said lever away from said first drum shell.

17. The device according to claim 15, wherein:
said shaker has a rear wall being spaced from a front wall;
a rear surface of said rear wall is attached to said second portion of said lever at a point being aligned with said second end of said lever;
said shaker has a plurality of dividers;
each divider of said plurality of dividers extends between said front wall and said rear wall of said shaker to define a plurality of chambers within said shaker; and
said plurality of dividers is spaced apart from each other and is distributed between a top wall of said shaker and a bottom wall of said shaker.

18. The device according to claim 17, wherein:
each bead of said plurality of beads is located within a respective one of said plurality of chambers within said shaker;
each chamber of said plurality of chambers limits a distance that each bead of said plurality of beads can travel within said shaker when said lever is pivoted such that each chamber of said plurality of chambers minimizes a duration of time between said lever being pivoted and said plurality of beads striking against said shaker wherein said shaker is configured to produce the audible sound as soon as possible when said lever is pivoted; and
each bead of said plurality of beads is comprised of a rigid material wherein each bead of said plurality of beads is configured to enhance an intensity of the audible sound produced by said plurality of beads striking against said shaker.

19. A portable hand drum device being playable with hands of a user to produce a variety of percussive sounds, said device comprising:
a first drum shell being comprised of an acoustically resonant material wherein said first drum shell is configured to amplify sound waves that travel through said first drum shell, said first drum shell having a first end and a second end and an outer wall extending between said first end and said second end, each of said first end and said second end being open wherein each of said first end and said second end are configured to pass air through said first drum shell such that sound waves can pass through said first drum shell, said first drum shell having a plurality of sound holes each extending through said outer wall of said first drum shell wherein each sound hole of said plurality of sound holes is configured to pass air through said outer wall, said plurality of sound holes including a central hole and a plurality of outer holes being distributed around said central hole, said plurality of sound holes being centrally located between said first end and said second end of said first drum shell, said first drum shell having a first cable hole extending through said outer wall, said first cable hole being located closer to said first end than said second end, said first drum shell having a second cable hole extending through said outer wall, said second cable hole being positioned on an opposite side of said outer wall with respect to said first cable hole having said second cable hole being aligned with said first cable hole, said first drum shell having a spring hole extending through said outer wall, said spring hole being positioned between said second cable hole and said second end of said first drum shell having said spring hole being aligned with said second cable hole, said first drum shell having a lever hole extending through said outer wall, said lever hole being positioned closer to said second end of said first drum shell than said first end of said first drum shell, said lever hole being positioned between said plurality of sound holes and said second end of said first drum shell;
a shoulder strap being attached to said first drum shell wherein said shoulder strap is configured to be worn over a shoulder of a user thereby positioning said first drum shell on a front side of the user's upper body such that hands of the user can touch said first drum shell, said shoulder strap having a primary end and a secondary end;
a pair of retainers, each retainer of said pair of retainers being attached to a respective one of said primary end and said secondary end of said shoulder strap, each retainer of said pair of retainers having an annular hoop being formed into a respective retainer;
a pair of strap mounts, each strap mount of said pair of strap mounts being attached to an outer surface of said outer wall of said first drum shell, each strap mount of said pair of strap mounts being spaced from a respective one of said first end and said second end of said first drum shell having said pair of strap mounts being aligned with each other, each strap mount of said pair of strap mounts including a hoop being movably attached to a respective strap mount;
a pair of annular rings, each annular ring of said pair of annular rings extending through said annular hoop of a respective retainer and said hoop of a respective strap mount such that said shoulder strap is movably attached to each strap mount of said pair of strap mounts;
a first drum head being removably attachable to said first drum shell, said first drum head being comprised of a resonant material wherein said first drum head is configured to produce an audible sound when said first drum head is struck;
a plurality of drum lugs, each drum lug of said plurality of drum lugs being attached to said outer surface of said outer wall of said first drum shell, said plurality of drum lugs being spaced from said first end of said first drum shell, said plurality of drum lugs being evenly spaced apart from each other and being distributed around a full circumference of said outer wall of said first drum shell;
a first drum hoop being positionable on said first end of said first drum shell such that said first drum hoop extends around a full circumference of said first end, said first drum hoop having a plurality of first tabs each extending laterally away from said first drum hoop, said plurality of first tabs being evenly spaced apart from each other and being distributed around a full circumference of said first drum hoop, said first drum hoop being oriented on said first end such that each first tab of said plurality of first tabs is aligned with a respective one of said plurality of drum lugs, said first drum head being positioned between said first drum hoop and said first end of said first drum shell such that said first drum hoop retains said first drum head on said first end;
a plurality of first tension screws, each first tension screw of said plurality of first tension screws extending through a respective one of said plurality of first tabs on said first drum head and into a respective one of said plurality of drum lugs for tightening said first drum hoop onto said first end of said first drum shell thereby tensioning said first drum head when each first tension screw of said plurality of first tension screws is tightened in said respective drum lug, each first tension screw of said plurality of first tension screws having a head which compresses against said respective first tab on said first drum hoop to inhibit each first tension screw of said plurality of first tension screws from passing through said respective first tab when said plurality of first tension screws is tightened in said respective drum lug;
a striking rod being pivotally attached to said first drum shell wherein said striking rod is configured to be depressed by a respective one of the user's hands when the user is wearing said shoulder strap;
a beater rod being pivotally coupled to said first drum shell, said beater rod being in mechanical communication with striking rod, said beater rod being in mechanical communication with said first drum head such that said beater rod strikes said first drum head when said striking rod is depressed wherein said first drum head is configured to produce the audible sound when the user depresses said striking rod;
a striker pivot being attached to said outer surface of said outer wall of said first drum shell, said striker pivot being positioned between said first cable hole and said second end of said first drum shell having said striker pivot being positioned closer to said first cable hole than said second end, said striking rod being pivotally attached to said striker pivot such that said striking rod is oriented parallel to said outer surface of said outer wall of said first drum shell when said striking rod is in a ready position wherein said striking rod is configured to be depressed by the user, said striking rod being positioned in said striker pivot such that a first end of said striking rod is aligned with said first end of said first drum shell wherein a portion of said striking rod that extends between said striker pivot and a second end of said striking rod is configured to be pressed upon by the user, said striking rod being pivotable into an actuating position having said second end of said striking rod being urged toward said outer wall of said first drum shell and having said first end of said striking rod being urged away from said outer wall of said first drum shell;
a striking sleeve extending around said striking rod, said striking sleeve being positioned between said striker pivot and said first end of said striking rod;
a beater pivot being attached to said outer surface of said outer wall of said first drum shell, said beater pivot being positioned between said second cable hole and said second end of said first drum shell having said beater pivot being positioned closer to said second cable hole than said second end of said first drum shell;
wherein said beater rod has a primary end and a secondary end and a bend located between said primary end of said beater rod and said secondary end of said beater rod, said bend defining a primary portion of said beater rod being oriented perpendicular to a secondary portion of said beater rod, said primary end of said beater rod being associated with said primary portion, said secondary end of said beater rod being associated with said secondary portion, said bend being positioned closer to said primary end of said beater rod than said secondary end of said beater rod, said secondary portion being pivotally attached to said beater pivot such that said secondary portion is oriented parallel to said outer surface of said outer wall and said primary portion extends partially across said first end of said first drum shell;
a beater sleeve extending around said secondary portion of said beater rod, said beater sleeve being positioned between said beater pivot and said bend in said beater rod;
a biasing member being coupled to said secondary portion of said beater rod such that said biasing member extends through said spring hole in said outer wall of said first drum shell;
a spring block being coupled to an inside surface of said outer wall of said first drum shell, said spring block being aligned with said spring hole in said outer wall of said first drum shell, said biasing member being coupled to said spring block such that said biasing member biasing said beater rod into a home position having said secondary portion being oriented parallel to said outer surface of said outer wall and having said primary portion being oriented parallel to said first drum head;
a beater having an outer surface being coupled to said primary end of said beater rod, said beater having a bottom surface being spaced from and being oriented parallel to said first drum head when said beater rod is in said home position, said bottom surface of said beater striking said first drum head when said beater rod is urged into a beating position having said beater rod being pivoted in said beater pivot wherein said first drum head is configured to produce the audible sound when said bottom surface of said beater strikes said first drum head;
a cable extending through each of said first cable hole and said second cable hole, said cable having a first end being coupled to said striking sleeve, said cable having a second end being coupled to said beater sleeve, said beater rod being urged into said beating position when said striking rod is urged into said actuating position such that said bottom surface of said beater strikes said first drum head, said striking rod being urged into said ready position when said biasing member biases said beater rod into said home position;
a second drum shell being coupled to said first drum shell, said second drum shell being perpendicularly oriented with said first drum shell wherein said second drum shell is configured to be accessible to a respective hand of the user when the user is wearing said shoulder strap, said second drum shell being comprised of an acoustically resonant material wherein said second drum shell is configured to amplify sound waves that travel through said second drum shell, said second drum shell extending laterally away said outer surface of said outer wall of said first drum shell, said second drum shell surrounding said plurality of sound holes in said outer wall of said first drum shell, said second drum shell having a distal end with respect to said outer wall, said distal end being open wherein said second drum shell is configured to pass air through said distal end and said plurality of sound holes, said second drum shell being oriented such that said distal end lies on a plane being oriented parallel an axis extending through said first end of said first drum shell and said second end of said first drum shell;
a second drum head being removably attachable to said second drum shell wherein said second drum head is configured to be struck by a respective one of the user's hands when the user is wearing said shoulder strap, said second drum head being comprised of a resonant material wherein said second drum head is configured to produce an audible sound when said second drum head is struck by the user's respective hand having the audible sound traveling through said plurality of sound holes in said outer wall of said first drum shell such that said first drum shell can amplify the audible sound produced by said second drum head, said second drum shell being located proximate said second end of said striking rod wherein said second drum shell is configured to be positioned such that the user can strike said second drum head or depress said striking rod with the same hand;
a second drum hoop being positionable on said distal end of said second drum shell such that said second drum hoop extends around a full circumference of said distal end, said second drum hoop having a plurality of second tabs each extending laterally away from said second drum hoop, said plurality of second tabs being evenly spaced apart from each other and being distributed around a full circumference of said second drum hoop, said second drum head being positioned between said second drum hoop and said distal end of said second drum shell such that said second drum hoop retains said second drum head on said distal end of said second drum shell;
a plurality of snare wires, each snare wire of said plurality of snare wires being attached to said second drum hoop such that each snare wire of said plurality of snare wires extends across said second drum hoop, said second drum head resting against said plurality of snare wires wherein said plurality of snare wires is configured to produce a snapping sound when said second drum head is struck by the user's respective hand;
a plurality of second tension screws, each second tension screw of said plurality of tension screws extending through a respective one of said plurality of second tabs and extending into said outer wall of said first drum shell for tightening said second drum hoop on said distal end of said second drum shell when each second tension screw of said plurality of second tension screws is threaded into said outer wall of said first drum shell thereby tensioning said second drum head, each second tension screw of said plurality of second tension screws having a head which compresses against said respective second tab when said second tension screws are threaded into said outer wall to inhibit each second tension screw of said plurality of second tension screws from passing through said respective second tab when each second tension screw of said plurality of second tension screws is threaded into said outer wall of said first drum shell;
a lever being pivotally attached to said first drum shell wherein said lever is configured to be pivoted with a respective one of the user's hands when the user is wearing said shoulder strap, said lever having a first end and a second end and a pair of bends being located between said first end and said second end of said lever to define a middle portion of said lever extending between and being perpendicularly oriented with each of a first portion and a second portion of said lever, said first portion being associated with said first end of said lever, said second portion being associated with said second end of said lever, said middle portion of said lever extending through said lever hole in said outer wall of said first drum shell such that said first portion is positioned outside of said first drum shell and said second portion is positioned inside of said first drum shell;
a pivot block having a front surface and a back surface, said pivot block having a hole extending through said front surface and said back surface, said back surface being coupled to said outer surface of said outer wall of said first drum shell having said hole in said pivot block being aligned with said lever hole in said outer wall of said first drum shell such that said pivot block is located between said second end of said first drum shell and said second drum shell having said primary portion of said lever extending toward said second drum shell wherein said primary portion of said lever is configured to be located such that the user can pivot said lever and strike said second drum head while their hands are in a natural position, said middle portion of said lever extending through said hole in said pivot block, said pivot block having a pivot point being located in said hole in said pivot block, said middle portion of said lever being pivotally coupled to said pivot point;
a grip having a coupled end being coupled to said first end of said lever such that said grip is oriented colinear with said first portion of said lever wherein said grip is configured to be gripped by a respective one of the user's hands when the user is wearing said shoulder strap such that the user can pivot said lever toward said first drum shell;
a handle having a coupled end being coupled to an outside surface of said grip, said handle being oriented to angle away from said grip wherein said handle is configured to restrain the user's respective hand between said grip and said handle such that the user can pivot said lever away from said first drum shell;
a shaker being coupled to said lever such that said shaker is positioned within said first drum shell, said shaker having a rear wall being spaced from a front wall, a rear surface of said rear wall being attached to said second portion of said lever at a point being aligned with said second end of said lever, said shaker having a plurality of dividers, each divider of said plurality of dividers extending between said front wall and said rear wall of said shaker to define a plurality of chambers within said shaker, said plurality of dividers being spaced apart from each other and being distributed between a top wall of said shaker and a bottom wall of said shaker; and
a plurality of beads, each bead of said plurality of beads being positioned within said shaker, said plurality of beads striking against said shaker when said lever is pivoted wherein said shaker is configured to produce an audible sound when said lever is pivoted, each bead of said plurality of beads being located within a respective one of said plurality of chambers within said shaker, each chamber of said plurality of chambers limiting a distance that each bead of said plurality of beads can travel within said shaker when said lever is pivoted such that each chamber of said plurality of chambers minimizes a duration of time between said lever being pivoted and said plurality of beads striking against said shaker wherein said shaker is configured to produce the audible sound as soon possible when said lever is pivoted, each bead of said plurality of beads being comprised of a rigid material wherein each bead of said plurality of beads is configured to enhance an intensity of the audible sound produced by said plurality of beads striking against said shaker.
